(19) United States
(12) Patent Application Publication
(10) Pub. No.: US 2026/0140639 A1
(43) Pub. Date: May 21, 2026

(54) DATA STORAGE SYSTEM AND METHOD OF OPERATION THEREOF

(71) Applicant: Samsung Electronics Co., Ltd., Suwon-si (KR)

(72) Inventors: Seona WON, Suwon-si (KR); Sejong KIM, Suwon-si (KR); Suyong LEE, Suwon-si (KR); Jaeseo NOH, Suwon-si (KR)

(21) Appl. No.: 19/389,599

(22) Filed: Nov. 14, 2025

(30) Foreign Application Priority Data
Nov. 15, 2024 (KR) 10-2024-0163104

(51) Int. Cl. G06F 3/06

(52) U.S. Cl. CPC G06F 3/0619; G06F 3/0659; G06F 3/0679

(57) ABSTRACT

A data storage system includes a memory device, and a memory controller performing an operation command of an operation on the memory device, identifying an operation time of the operation, and determining a standby time based on the operation time to transmit a status identifying command to the memory device.

### CROSS-REFERENCE TO RELATED APPLICATIONS

This application claims the benefit of Korean Patent Application No. 10-2024-0163104, filed on Nov. 15, 2024, in the Korean Intellectual Property Office, the disclosure of which is herein incorporated by reference in its entirety.

### BACKGROUND

### 1. Field of the Invention

Example embodiments relate to a data storage system and a method of operating the same.

### 2. Description of the Related Art

A NAND flash is a type of flash memory that allows data to be freely written and erased. In general, the NAND flash has slower read speed than NOR flash, but has the advantage of fast programming and erasing speeds and can store large amounts of data. Accordingly, a wide range of portable storage devices and electronic products such as computers are widely used for data storage.

The controller that controls the NAND flash identifies the status of the NAND flash using the signal from a Ready/Busy (R/B) pin of the NAND flash. Here, when the power consumption and performance of the NAND flash are taken into account, the timing to transmit a command to identify the status of NAND flash is important. Meanwhile, a reading operation and a programming operation for the NAND flash are performed page by page, but an erasing operation is performed block by block. Here, each page and block can have structurally different characteristics.

### SUMMARY

An aspect provides a data storage system and an operation method of the same by which efficient memory use is possible based on the power consumption and performance of the memory device by setting the time to transmit a command for identifying an operation status of the memory device based on the cell type and location information in the memory device.

The technical tasks to be achieved by the present example embodiments are not limited to the technical tasks described above, and other technical tasks may be inferred from the following example embodiments.

According to an aspect of the present disclosure, a data storage system includes a memory device, and a memory controller performing an operation on the memory device according to an operation command, identifying an operation time of the operation, and determining a standby time based on the operation time to transmit a status identifying command to the memory device.

According to an aspect of the present disclosure, a data storage system includes a memory controller transmitting an operation command for an operation of a memory device in response to a host request, a memory device performing the operation according to the operation command, and a timing management module identifying an operation time of the operation, and performing an initializing operation to determine a standby time based on the operation time of the operation. The memory controller transmits, after the standby time is elapsed, a status identifying command to the memory device to identify status information of the memory device.

According to an aspect of the present disclosure, an operation method of a data storage system includes performing an initializing operation to determine a standby time based on an operation time for an operation of a memory device, and transmitting, after the standby time is elapsed, a status identifying command to identify status information of the memory device. The status information represents one of a busy status in which the operation is being performed at a time when the memory device receives the status identifying command and a ready status in which the operation is completed at a time or prior to a time when the memory device receives the status identifying command.

Additional aspects of example embodiments will be set forth in part in the description which follows and, in part, will be apparent from the description, or may be learned by practice of the disclosure.

According to example embodiments, it is possible to achieve optimal performance and minimize power consumption even with large amounts of data by determining the timing to transmit a status identifying command of the memory device by reflecting the characteristics of each chip.

Effects of the present disclosure are not limited to those described above, and other effects may be made apparent to those skilled in the art from the following description.

### BRIEF DESCRIPTION OF THE FIGURES

These and/or other aspects, features, and advantages of the invention will become apparent and more readily appreciated from the following description of example embodiments, taken in conjunction with the accompanying drawings of which:

FIG. 1 and FIG. 2 are block diagrams of a data storage system according to an example embodiment;

FIG. 3 is a drawing illustrating a memory device according to an example embodiment;

FIG. 4 is a timing diagram of a memory device according to an example embodiment;

FIG. 5 is a block diagram of a data storage system according to an example embodiment;

FIG. 6 and FIG. 7 are flowcharts of an operation method of a data storage system according to an example embodiment;

FIG. 8 is a flowchart of an operation method of a data storage system according to an example embodiment; and

FIG. 9 is a block diagram of a data storage system according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. In certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

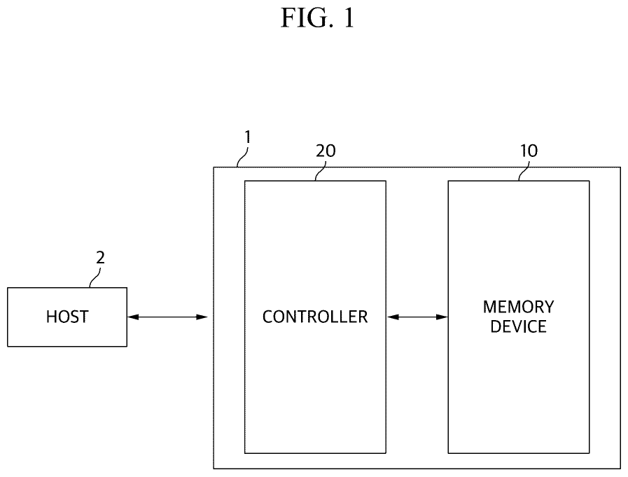

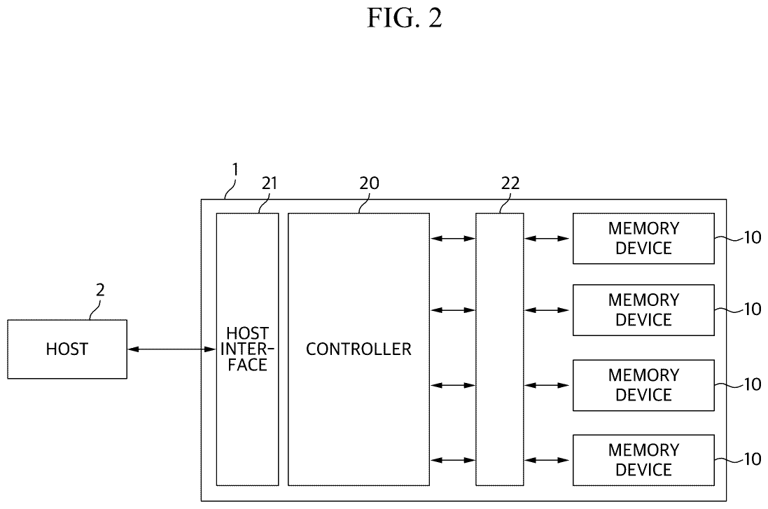

FIG. 1 and FIG. 2 are block diagrams of a data storage system according to an example embodiment.

Referring to FIG. 1, a data storage system (hereinafter, referred to as a “system 1”) according to example embodiments may include a memory device 10 and a controller 20. FIG. 1 illustrates a host 2 as an external device to the system 1, but in another example embodiment, the system 1 may further include the host 2.

The controller 20 may control the overall operation of the memory device 10, and control the overall data exchange between the host 2 and the memory device 10. For example, the controller 20 may read data from the memory device 10 or program data to the memory device 10 in response to a request from the host 2.

The controller 20 may control the operation of the memory device 10 using an operation command applied to the memory device. In an example embodiment, the host 2 may transmit a host request to the controller 20. For example, a host request may be a request to read specific data stored in the memory device 10. The controller 20 may transmit an operation command to the memory device 10 to perform an operation corresponding to a host request. Here, operations of the memory device 10 may include programming operations, reading operations (i.e., read operations), or erasing operations. The operation command may include at least one of a read command for a reading operation (i.e., a read operation), a programming command for a programming operation, and an erase command for an erasing operation. Here, the operation command may include information about the address of the memory device 10 for the above operation.

According to an example embodiment, the controller 20 may be connected to the memory device 10 via pins or terminals. Here, the controller 20 may be implemented as an application specific integrated circuit (ASIC) or a system on a chip (SOC).

According to an example embodiment, the memory device 10 may be a non-volatile memory (for example, a single-level flash memory or a multi-level flash memory). Here, the non-volatile memory may include NAND type flash memory modules. The NAND type flash memory module may include multiple interfaces for command, address and data. The commands, addresses and data may be sent and received through input/output (I/O) pins. The present disclosure is not limited thereto. In an embodiment, the memory device 10 may be electrically erasable programmable read-only memory (EEPROM), phase change random access memory (PRAM), resistance random access memory (RRAM), nano floating gate memory (NFGM), polymer random access memory (PoRAM), magnetic random access memory (MRAM), ferroelectric random access memory (FRAM) or similar memory. In another example embodiment, the memory device 10 may be implemented with various memories including dynamic random access memory (DRAM) such as double data rate synchronous dynamic random access memory (DDR SDRAM), low power double data rate (LPDDR) SDRAM, graphics double data rate (GDDR) SDRAM, and Rambus dynamic random access memory (RDRAM). In an embodiment, the memory device may include a memory cell array in which memory cells are vertically arranged on a substrate. For example, Vertical NAND (or V-NAND) includes memory cells stacked vertically in multiple layers each of which is referred to as a page. Memory cells of the same page may share a word line. For example, word lines WL0 to WLn may be vertically stacked (i.e., in a Z-direction perpendicular to an upper surface of a substrate. The memory cells in each page may be horizontally arranged on a plane defined by an X-direction and Y-direction parallel to the upper surface of the substrate.

According to an example embodiment, the memory device 10 may perform an operation according to an operation command.

According to an example embodiment, the host 2 may communicate with the memory device 10 using a given interface protocol. Description of the host interface will be provided later through FIG. 2.

Below, example embodiments described with reference to FIG. 2 may also be applied to the example embodiments with reference to FIG. 1.

Referring to FIG. 2, the system 1 may include a plurality of the memory devices 10. The plurality of memory devices 10 may be connected to a memory interface 22. For example, the memory interface 22 may connect the controller 20 to the plurality of memory devices 10.

The memory interface 22 may include a channel of each of the plurality of memory devices 10. Here, the channel may be a channel including one or more I/O lines, a chip selecting signal line, a signal line for a signal (e.g., a Ready/Busy signal) representing status information of the memory device 10. For example, the memory interface 22 may be an I/O interface. In an example embodiment, the host 2 may communicate with the plurality of memory devices 10 via the memory interface 22 connected to the controller 20.

According to an example embodiment, the system 1 may further include a host interface 21. The host interface 21 may be an interface between the host 2 and the system 1. For example, the host interface 21 may be any one of the interface protocols such as advanced technology attachment (ATA), serial ATA (SATA), parallel ATA (PATA), serial attached SCSI (SAS), personal computer memory card international association (PCMCIA), small computer system interface (SCSI), and universal flash storage (UFS). However, the host interface 21 is not limited thereto. The host interface 21 may be one of several interface protocols, such as universal serial bus (USB), multi-media card (MMC), enhanced small disk interface (ESDI) and integrated drive electronics (IDE). The host interface 21 may communicate with the system 1 (for example, the controller 20) using any one or more of the example embodiments described above.

According to an example embodiment, the host 2 may send a high-level request (e.g., a read request, a programming request, or an erase request) and a logical address via the host interface 21 to the controller 20, and the controller 20 may translate the high-level request to a specific command (e.g., a read command, a program command, or an erase command), with mapping of the logical address to a chip select signal to select a memory device among the memory devices 10 and a physical address within the selected memory device.

According to an example embodiment, the memory device 10 may include a memory cell array (not illustrated) and a sub-controller (not illustrated). The memory cell array (not illustrated) may include a plurality of memory cells connected to a plurality of word lines WL and a plurality of bit lines BL. The memory cell array (not illustrated) may be divided into multiple memory blocks, and each of the plurality of memory blocks may include a plurality of pages. For example, one page may contain one memory cell row linked to the same word line WL. Reading operations or programming operations performed on a memory cell array (not illustrated) may be performed on a page-by-page basis, and the erasing operation may be performed on a block-by-block basis. A sub-controller (not illustrated) may decode operation commands to generate control signals to perform an operation corresponding to an operation command on a target page or target block of a memory cell array (not illustrated) corresponding to a host request.

According to an example embodiment, the memory device 10 may include one or more single-level cell (SLC) devices. The memory device 10 may include one or more multi-level cell (MLC) devices. The MLC may be structured to store 2 bits per cell, or may be structured to store more than 2 bits per cell (for example, a triple-level cell (TLC) and a quad-level cell (QLC)).

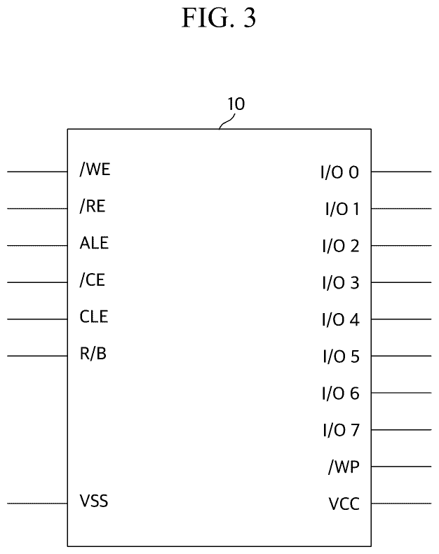

FIG. 3 is a drawing illustrating a memory device according to an example embodiment.

Referring to FIG. 3, the memory device 10 has multiple I/O pins, WP (Write Protect) pins, VCC (Voltage Controller) pins, VSS (Voltage Source) pins, R/B (Ready/Busy) pins, CLE (Command Latch Enable) pins, CE (Chip Enable) pins, ALE (Address Latch Enable) pins, RE (Read Enable) pins and WE (Write Enable) pins.

According to an example embodiment, the I/O pins (for example, I/O 1 to I/O 7 in FIG. 3) are pins for inputting and outputting data and addresses, and the memory device 10 may share address and data lines on a single port. Therefore, the memory device 10 may include a CLE pin and an ALE pin to distinguish whether data transmitted through a port is a command or an address.

According to an example embodiment, the CLE pin may indicate that a command such as a read command, a programming command, or an erase command is output through the I/O bus. For example, when the signal on the CLE pin is at a logic level high, the data output to the I/O bus may be a command to be sent to the memory device 10. For example, when the CLE pin is at a logic level high, the memory device 10 may interpret the data driven onto the I/O bus as a command or as a command cycle.

According to an example embodiment, the ALE pin may indicate that address information is output via the I/O bus. For example, when the signal on the ALE pin is at a logic level high, the data output to the I/O bus may be address information sent to the memory device 10. For example, when the ALE signal is at a logic level high, the memory device 10 may interpret the data driven onto the I/O bus as an address or as an address cycle. The data for a read or write operation may be transferred via the I/O bus when both the CLE pin and ALE pin signals are at a logic level low.

According to an example embodiment, the RE pin and the WE pin are pins that indicate reading and programming data, and when data is read, the RE pin may be a logic level low, and when programming the data, the WE pin may be at a logic level low.

According to an example embodiment, the CE pin may indicate whether a controller is using the memory device 10. For example, the CE pin is used to select a specific memory device when multiple memory devices share the same I/O bus. When the memory devices 10 of FIG. 2 are connected to a common I/O bus for the data pin, the CLE pin, or ALE pin, and when the CE pin is at a logic level low, the memory device may latch commands, addresses, or data. When the CE pin is at a logic level high, the memory device 10 ignores inputs and does not drive the I/O bus.

According to an example embodiment, the R/B pin is a pin that indicates status information of the memory device 10, and when the R/B pin is at logic level low, it may indicate that the memory device 10 is in a busy status and when the R/B pin is at a logic level high, it may indicate the ready status.

The operation of the memory device 10 may be performed as command transmission, operation of the memory device 10, confirmation of success of operation of the memory device 10, and subsequent operation (for example, reading, programming, erasing and so on). Here, the status information corresponding to the operation of the memory device 10 may be identified through the R/B pin of the memory device 10.

Specifically, the value of the R/B pin may be at a logic level low when the memory device 10 is operating and the value of a logic level of the R/B pin may normally be high when the operation of the memory device 10 is completed and the device is in an available status. Therefore, the status information of the memory device 10 may be identified by referring to the R/B pin (i.e., by monitoring a logic level of the R/B pin).

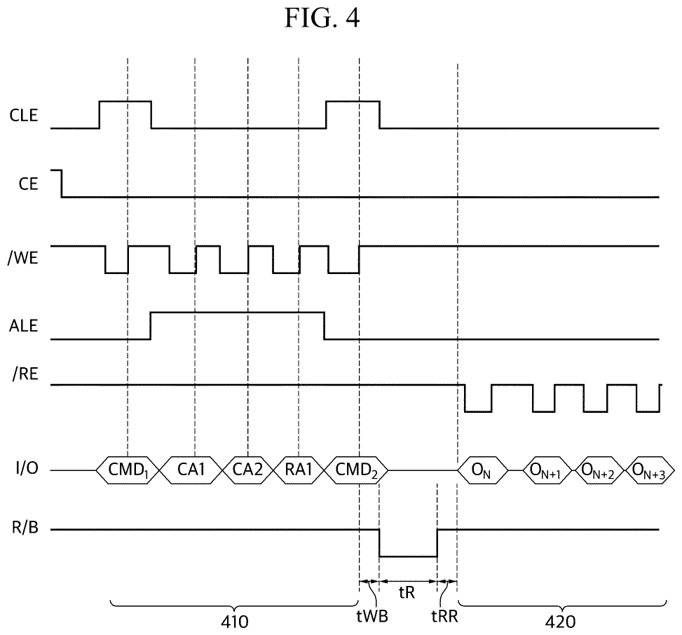

FIG. 4 is a timing diagram of a memory device according to an example embodiment.

Referring to FIG. 4, the timing diagram for each pin related to a reading operation of the memory device is illustrated. Hereinafter, an example embodiment is described in which the operation command is a read command, but the example embodiments of the present disclosure are not limited the reading operation. The example embodiments of the present disclosure may be applied to various operations that the memory device 10 may perform.

According to an example embodiment, the controller may perform operations according to operation commands regarding the operation of the memory device. Here, the controller may identify an operation period of time (i.e., an operation time) (e.g., a read time t_{R} in a read operation, a programming time t_{PROG} in a programming operation) for the operation. The operation period of time (t_{R}) is related to the time it takes for the memory device to perform an operation, and specifically, may be set differently depending on the signal output from each pin of the memory device.

For example, referring to FIG. 4, a section 410 may be a section where an operation command is transmitted to the memory device, and a section 420 may be a section where data is read from the memory device according to an operation command.

According to an example embodiment, the write or programming signal WE may be pulsed to apply row address information RAI and column address information CA1 and CA2 to the memory device. For example, in response to the write or programming signal WE, the memory device may latch the row address information RAI and the column address CA1 and CA2. The command CMD₁ of the I/O pin may be an address command, and the command CMD₂ of the I/O pin may be a start command. The read enable signal RE may be pulsed (i.e., may be asserted in a timed sequence) to read data such as O_{N}, O_{N+1}, O_{N+2}, O_{N+3}, . . . from the memory device.

According to an example embodiment, the signal of the R/B pin may output the status information of the memory device. Specifically, the signal of the R/B pin may indicate whether the target page of the memory device is in a busy status or a ready status. For example, regarding the target page from which data is to be read, when the signal of R/B pin is at a logic level low, it may indicate that the target page is in a busy status, and when the signal of the R/B pin is at a logic level high, it may indicate that the target page is in the ready status. In the example embodiment, identified is that after a certain amount of time has passed since the last rising edge of the write enable signal WE, a logic level of the signal at the R/B pin becomes logic level high which indicating a ready status.

Meanwhile, the operation period of time (t_{R}) of the reading operation of the memory device corresponding to the operation command for the reading operation may be the time taken from the falling edge, which is of the R/B pin after a predetermined time (t_{WB}) has elapsed from the start command (CMD₂), to the rising edge of the R/B pin. This may correspond to the read time for reading data from the memory device, and the operation period of time (t_{R}) may represent the performance of a memory device, and more specifically, may represent the performance according to the cell type of the target page. Here, the data from the memory device may be read out by the controller after a predetermined time (t_{RR}) has elapsed from the rising edge of the R/B pin.

According to an example embodiment, the memory device may include a plurality of groups determined based on at least one of the cell type of each of the plurality of pages included in the memory device and location information.

In an example embodiment, each memory cell or each of the plurality of pages of the memory device may have a cell type such as the SLC, the MLC, the TLC and the QLC as described above. Here, memory devices may have different operation periods of time depending on the cell type. For example, the capacity of a memory device may vary depending on the cell density of each cell type, and there may be differences in the operation period of time depending on the capacity. There may be differences in the operation period of time depending on the location information of the memory device. For example, when the memory device is VNAND flash memory, there may be a difference in the operation period of time between the top layer and the bottom layer due to structural differences according to the process. In an example embodiment, the operation period of time of the top layer may be shorter than that of the bottom layer. Therefore, each memory cell or each of the plurality of pages may have a different operation period of time depending on the location information in the memory device.

In other words, pages that have at least one of the page cell type and location information characteristics identical or similar may be classified into the same group, and accordingly, each of the plurality of pages may be included in any one of a plurality of groups. However, when the operation command is an erase command, the plurality of pages in the following example embodiments may be described by being replaced with a plurality of blocks. For example, pages that have at least one of the block structure and the location information identical or similar may be classified into the same group. Accordingly, each of the plurality of blocks may be included in any one of the plurality of groups.

According to an example embodiment, the controller may use the status information of the memory device to determine whether the memory device can perform the operation corresponding to the operation command. For example, the controller may transmit a status identifying command to the memory device, the controller may identify the signal of the R/B pin of the memory device and transmit the operation command when it is in the ready status, the controller does not allow access when it is in a busy status, and the controller may transmit the status identifying command again after a certain period of time has passed (e.g., at time when a standby period of time ends, which will be discussed below). Here, in transmitting the operation command, the timing to transmit the status identifying command is important due to limitations on the amount of data per second that may be transmitted and received between devices. For example, the status identifying command may be transmitted using the data pins which are also used for data for a read operation or data for a programming operation, and frequent issuing of the status identifying command may lower performance of the system 1 (e.g., a lower bandwidth and more power consumption). When the standby period of time (i.e., the standby time) for transmitting the status identifying command is shorter than the appropriate time, the amount of unnecessary commands sent may increase, and when the standby period of time is longer than the appropriate time, the time of the ready status of the memory device may become longer, which may result in reduced speed and performance. Therefore, it is important to set an appropriate standby period of time for the memory device.

According to the example embodiment again, the controller may identify the operation period of time (t_{R}) for the operation according to the operation command. For example, the controller may identify information about the time at which a signal corresponding to the status information of the memory device was generated. Specifically, the controller may identify information (for example, information about the time when the memory device changed from the busy status to the ready status) about the time when the signal of the R/B pin of the memory device is at a logic level high or at a logic level low. After then, the controller may identify the plurality of operation periods of time according to the operation characteristics of each of the plurality of pages. The operation characteristics of each of the plurality of pages may be the signal timing of the R/B pin according to at least one of the page cell type and location information. The example embodiment in which the operation period of time (for example, t_{R}) is determined is the same as described above, and the controller may store the operation period of time of each of the plurality of pages. Here, the operation period of time of each of the plurality of pages may be stored multiple times as data is programmed and read multiple times.

According to an example embodiment, the controller may determine the standby period of time for transmitting the status identifying command based on the operation period of time. Hereinafter, the process by which the controller determines the standby period of time is defined as an initializing operation. Meanwhile, the standby period of time of each of the plurality of groups may be determined based on the characteristics of at least some of the plurality of pages included in each of the plurality of groups. The characteristics of at least some of the plurality of pages in each group may correspond to at least one of the signal timing of the R/B pin according to at least one of the page cell type. Since pages that have at least one of the page cell type and location information characteristics identical or similar are classified into the same group, the controller may determine the standby period of time based on the characteristics of the plurality of pages included in each of the plurality of groups. Here, since the plurality of pages included in an arbitrary group may not have the same characteristics, the controller may determine the standby period of time based on the characteristics of at least some pages that have these representative characteristics (for example, the characteristic that has the greatest influence on the operation period of time). In an example embodiment, the standby period of time may be determined independently for each of the plurality of groups.

According to an example embodiment, the standby period of time may be determined for each of the reading operation and the programming operation. In other words, each of the plurality of pages may be included in any one of a plurality of groups regarding the reading operation, and may be included in any one of a plurality of groups regarding programming operations at the same time. Accordingly, the standby period of time may be determined independently for each of the plurality of groups regarding the type of operation.

Specifically, according to an example embodiment, the controller may identify the plurality of operation periods of time of the target group among the plurality of groups. Here, the target group refers to a group for which a standby period of time is to be set among the plurality of groups of the memory device.

According to an example embodiment, the controller may produce a representative value of a plurality of operation periods of time for the identified target group. In an example embodiment, the representative value may be the most frequent value. For example, when the plurality of operation periods of time of the saved target group are 60 ns, 61 ns, 60 ns, 60 ns, 69 ns, 60 ns and 57 ns, the representative value may be calculated as 60 ns, which is the most frequent value. In another example embodiment, the representative value may be an average value. For example, when the plurality of operation periods of time of the saved target group are 60 ns, 61 ns, 60 ns, 60 ns, 69 ns, 60 ns and 57 ns, the representative value may be calculated as the average value of 61 ns. However, the representative value is not limited to the most frequent value or average value, and may vary depending on the various example embodiments.

According to an example embodiment, the controller may determine the representative value as the standby period of time of the target group. For example, when the representative value is the most frequent value in the above-described example embodiment, the standby period of time of the target group may be determined as 60 ns.

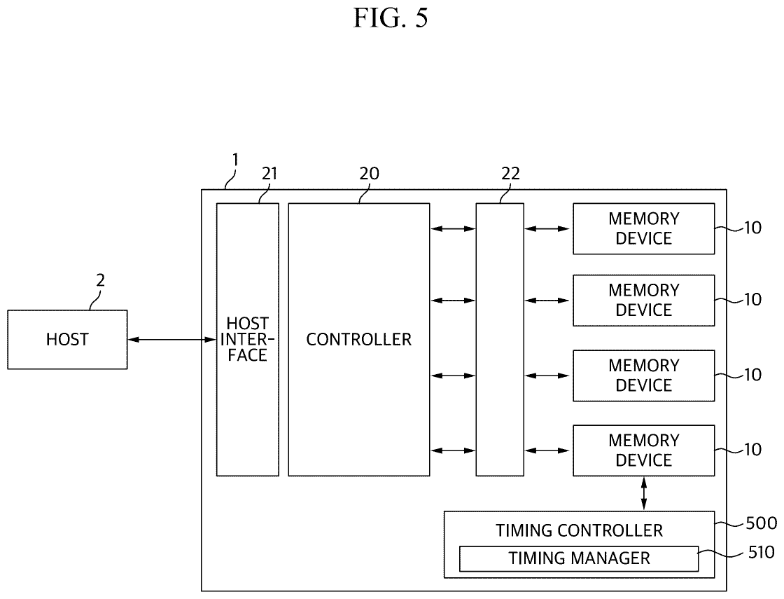

FIG. 5 is a block diagram of a data storage system according to an example embodiment.

According to an example embodiment, the system 1 may include a timing controller 500. The timing controller 500 may include a timing management module 510 that performs an initializing operation. Specifically, the timing management module 510 may identify an operation period of time for an operation, and determine a standby period of time based on the operation period of time. In other words, the timing management module 510 may be a module that determines the standby period of time for each of a reading operation and a programming operation of a plurality of pages included in the memory device 10, or may be a module that determines a standby period of time for the erasing operation of each of multiple blocks. The initializing operation performed by the timing management module 510 may be as follows. In an embodiment, the timing controller 500 may be included in the controller 20.

According to an example embodiment, the timing management module 510 may identify information about the time at which a signal corresponding to status information was generated, and store a plurality of operation periods of time for each of a plurality of pages based on information about the time.

According to an example embodiment, the timing management module 510 may identify the plurality of operation periods of time of each of the plurality of pages included in the target group among the plurality of groups, produce a representative value of the identified plurality of operation periods of time, and determine the representative value as the standby period of time of the target group. In an example embodiment, the representative value may be the most frequent value.

According to an example embodiment, the controller may transmit a status identifying command to identify status information after a determined standby period of time has elapsed. In an example embodiment, the controller may transmit a status identifying command to the memory device 10 to identify status information after a start command has been input and a determined standby period of time has elapsed. Specifically, the controller may identify a group among a plurality of groups that contains a target page corresponding to the operation command. The target page may be the page corresponding to the address information included in the operation command. After then, the controller may identify the determined standby period of time of the identified group, and transmit a status identifying command to the target page after the identified standby period of time has elapsed. Here, the controller may identify the determined standby period of time of a group that is identified from the timing controller 500 and the timing management module 510. In an embodiment, the timing controller 500 may be part of the controller 20 of FIG. 2. For example, the timing management module 510 may be implemented as a circuit, a firmware operated in the controller 20, or a combination thereof.

According to an example embodiment, the controller may reset the standby period of time at each tuning cycle of the memory device 10. The operation that resets the standby period of time for each tuning cycle is defined as a tuning operation. Here, the process of the tuning operation of the controller may be identical to the process according to the example embodiment of the initializing operation. In other words, the tuning operation may include identifying the operation period of time of each of the plurality of pages or blocks stored based on information on the time at which a signal of the memory device 10 is generated, calculating their representative value and determining the produced representative value as their tuned standby period of time.

According to an example embodiment, the tuning cycle may be determined based on at least one of a temperature of the memory device (for example, average temperature), a number of program/erase cycles performed on the memory device, and the bit error count of the memory device 10. For example, as the temperature of the memory device 10 increases and the number of program/erase cycles performed increases, the endurance and performance of the memory device 10 may decrease. As the bit error count (or the error bit count) of the memory device 10 increases, the performance of the memory device 10 decreases. As the performance of the memory device 10 decreases, the operation period of time of each of the plurality of pages or blocks included in the memory device 10 may increase. Accordingly, the controller may reset the standby period of time to transmit the status identifying command at each tuning cycle, and the tuning cycle may be determined based on the aforementioned characteristics of the memory device 10. The tuning cycle may be determined by a period (for example, 1 year), and may also be determined by P/E cycles (for example, 1000 times). In an embodiment, the memory device 10 may include at least one temperature sensor to monitor a temperature of the memory device 10.

Meanwhile, depending on the example embodiment, the tuning cycle may be determined based on the settings by a user rather than a fixed cycle, and for this, a user may provide a set value or set values to the data storage system. When another data storage system performs a specific operation in response to a request of the user, the standby period of time for transmitting the status identifying command may be reset. In an example embodiment, in response to a request of a user, when the data storage system starts operation, the standby period of time for transmitting the status identifying command may be reset.

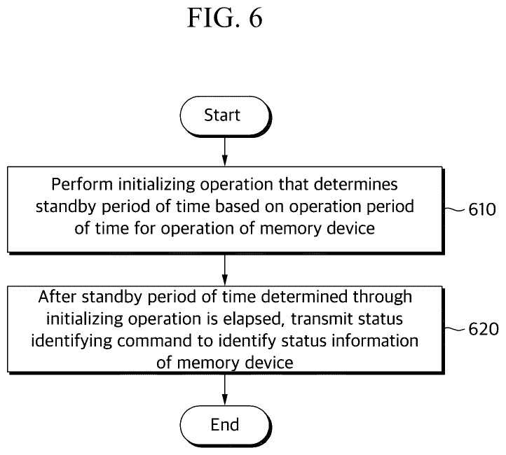

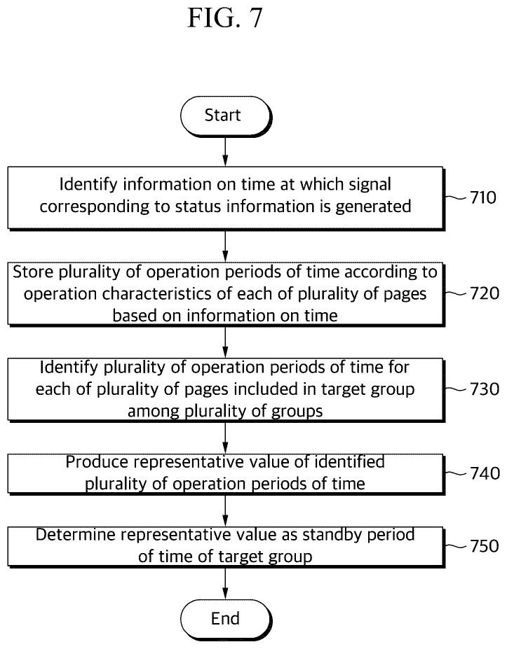

FIG. 6 and FIG. 7 are flowcharts of an operation method of a data storage system according to an example embodiment.

Referring to FIG. 6, in operation 610, the controller may perform an initializing operation that determines the standby period of time based on the operation period of time for the operation of the memory device. According to an example embodiment, the initializing operation may be performed by a timing management module. In an example embodiment, the initializing operation may be performed according to the flowchart of FIG. 7.

Referring to FIG. 7, in operation 710, the controller may identify information on the time at which the signal corresponding to the status information was generated. For example, the status information may include a busy status and a ready status. The signal corresponding to the status information may be a signal from the R/B pin of the memory device. In an embodiment, a memory device may output a signal representing that the memory device is executing a read operation during a read time t_{R}, a programming operation during a programming time t_{PROG}, or an erase operation during an erase time t_{BERS}. When the times t_{R}, t_{PROG}, or t_{BERS} ends, the memory device may output a signal representing that memory device has finished the operations, and may be ready to accept new commands.

In operation 720, the controller may store a plurality of operation periods of time according to the operation characteristics of each of the plurality of pages based on the information on the time. The memory device may include a plurality of groups determined based on at least one of the cell type of each of the plurality of pages included in the memory device and location information, and here, each of the plurality of pages may be included in any one of the plurality of groups. Therefore, the controller may store a plurality of operation periods of time for each of the plurality of pages based on the information on the time.

In operation 730, the controller may identify the plurality of operation periods of time for each of the plurality of pages included in the target group among the plurality of groups. For example, the controller may identify the plurality of operation periods of time for each of the plurality of pages included in the target group from the timing management module.

In operation 740, the controller may produce a representative value of the identified plurality of operation periods of time. In an example embodiment, the representative value may be the most frequent value.

In operation 750, the controller may determine the representative value as the standby period of time of the target group. Specifically, the standby period of time of each of the plurality of groups may be determined based on characteristics of at least some of the plurality of pages included in each of the plurality of groups.

Referring back to FIG. 6, in operation 620, after the standby period of time determined through the initializing operation has elapsed, the controller may transmit a status identifying command to identify the status information of the memory device. In an example embodiment, the controller may identify a group among a plurality of groups that contains the target page corresponding to the operation command, identify the determined standby period of time of the identified group, and transmit the status identifying command to the target page after a standby period of time has elapsed since the previous command was sent to the target page.

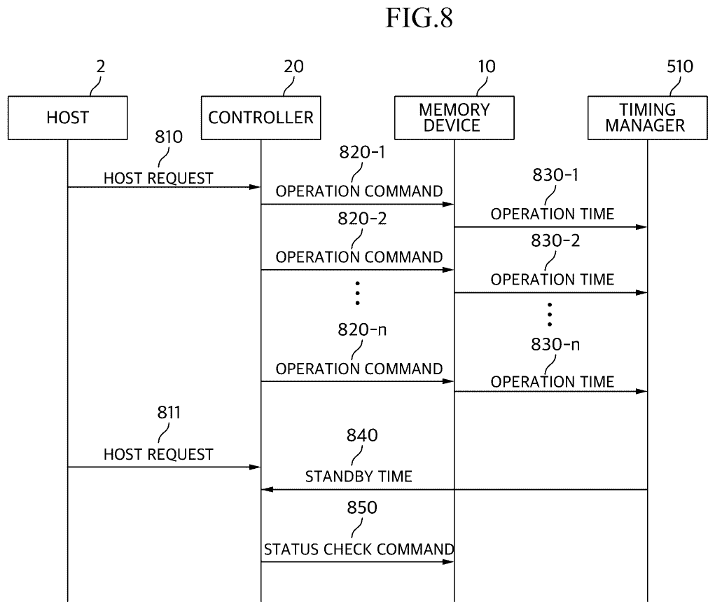

FIG. 8 is a flowchart of an operation method of a data storage system according to an example embodiment.

According to an example embodiment, the host 2 may transmit a host request to the controller 20 in operation 810. For example, the host request may be a request to read or erase some data from the memory device 10 or a request to program some data to the memory device 10.

According to an example embodiment, in operation 820-1, the controller 20 may transmit to the memory device 10 an operation command regarding an operation of the memory device 10 in response to the host request. According to an example embodiment, the memory device 10 may perform an operation corresponding to the operation command, and the timing management module 510 may identify (or store) the operation period of time for the operation of the memory device 10 in operation 830-1.

Meanwhile, as multiple operation commands are transmitted to the memory device in operation 820-1 to operation 820-n, the timing management module 510 may identify a plurality of operation periods of time in operation 830-1 to operation 830-n. Meanwhile, even though FIG. 8 illustrates that a single host request is transmitted in operation 810, there is omission for convenience of explanation, and example embodiments of the present disclosure are not limited thereto.

According to an example embodiment, the timing management module 510 may perform an initializing operation that determines a standby period of time based on an operation period of time.

According to an example embodiment, the host 2 may transmit another host request to the controller 20 in operation 811. Here, the controller 20 may identify a group among a plurality of groups that includes a target page corresponding to an operation command in response to the host request and identify the determined standby period of time of the group from the timing management module 510 in operation 840.

According to an example embodiment, the controller 20 may transmit a status identifying command to the memory device 10 after a determined standby period of time of the identified group has elapsed in operation 850.

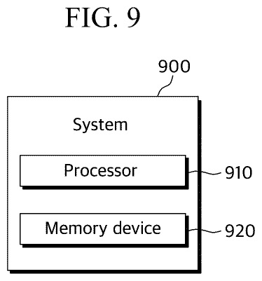

FIG. 9 is a block diagram of a data storage system according to an example embodiment.

Referring to FIG. 9, a system 900 may include a processor 910 and a memory device 920. FIG. 9 illustrates only the components relevant to the embodiment of the system 900. Therefore, it will be apparent to those skilled in the art that other general components may be included in addition to the components illustrated in FIG. 9. The system 900 and the memory device 920 may be identical to the system 1 and the memory device 10 described above with reference to FIG. 1 to FIG. 8, or may be configured to perform the same functions as the system 1 and the memory device 10 described above through FIG. 1 to FIG. 8.

FIG. 9 illustrates the single processor 910, but the system 900 may include any number of processors, each processor may be a single-core or a multi-core processor, each processor may implement either a reduced instruction set computer (RISC) architecture or a complex instruction set computer (CISC) architecture (among other possibilities), and each processor may be mixed and matched with any architecture combination. The memory device 920 may have a separate processor.

As hardware that stores various data processed within the system 900, the memory device 920 may store programs for processing and controlling the processor 910.

The memory device 920 may include random access memory (RAM) such as dynamic random access memory (DRAM), static random access memory (SRAM), read-only memory (ROM), electrically erasable programmable read-only memory (EEPROM), CD-ROM, Blu-ray or other optical disk storage, hard disk drive (HDD), solid status drive (SSD), or flash memory.

The processor 910 controls the overall operation of the system 900. For example, the processor 910 may control an input receiving part (not illustrated), a display (not illustrated), a communication unit (not illustrated) and the memory device 920 by executing programs stored in the memory device 920. The processor 910 may control the operation of the system 900 by executing programs stored in the memory device 920.

The processor 910 may control at least some of the operations of the devices described in FIG. 1 to FIG. 8.

The processor 910 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

According to an example embodiment, the system 900 may be a server. A server may be implemented as a computer device or multiple computer devices that communicate over a network to provide commands, codes, files, content, and services.

Meanwhile, the system 900 may further include a communication unit (not illustrated). The communication unit (not illustrated) may include one or more components that enable wired/wireless communication with an external server or external device. For example, the communication unit (not illustrated) may include at least one of a short-range communication unit (not illustrated), a mobile communication unit (not illustrated), and a broadcast receiving unit (not illustrated).

A device according to the above described example embodiments may include a processor, a memory for storing and executing program data, permanent storage such as disk drives, communication ports to communicate with external devices and user interface devices such as touch panels, keys and buttons. Methods implemented as software modules or algorithms are computer readable codes or program instructions executable on the processor, and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, C#, python, Java, assembler, etc., including various algorithms implemented as a combination of data structures, processes, routines, or other programming constructs. Functional aspects may be implemented in an algorithm running on one or more processors. Functional aspects may be implemented in an algorithm running on one or more processors. The example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A data storage system comprising:
a memory device; and
a memory controller configured to:
perform an operation on the memory device according to an operation command;
identify an operation time of the operation; and
determine a standby time based on the operation time to transmit a status identifying command to the memory device.

2. The data storage system of claim 1,
wherein the memory device comprises a plurality of pages which are grouped into a plurality of groups based on at least one of a memory cell type of each page of the plurality of pages and location information of each page of the plurality of pages, and
wherein each page of the plurality of pages is included in any one group of the plurality of groups.

3. The data storage system of claim 2,
wherein the standby time of each of the plurality of groups is determined based on characteristics of at least some of the plurality of pages included in each of the plurality of groups.

4. The data storage system of claim 2,
wherein the memory controller is configured to
identify information on a time at which a signal corresponding to status information of the memory device is updated; and
store a plurality of operation times of the plurality of pages based on the information on the time.

5. The data storage system of claim 4,
wherein the memory controller is configured to:
identify the plurality of operation times of each page of multiple pages included in a target group among the plurality of groups;
calculate a representative value of the plurality of operation times; and
determine the representative value as the standby time of the target group.

6. The data storage system of claim 5,
wherein the representative value is a most frequent value among the plurality of operation times.

7. The data storage system of claim 4,
wherein the memory controller is configured to transmit the status identifying command to identify the status information to the memory device, after the standby time is elapsed.

8. The data storage system of claim 7,
wherein the memory controller is configured to:
identify a target group, among the plurality of groups, that comprises a target page corresponding to the operation command;
identify the standby time of the target group; and
transmit the status identifying command to the target page after the standby time is elapsed.

9. The data storage system of claim 1,
wherein the memory controller is configured to perform a tuning cycle on the memory device to reset the standby time, and
wherein the tuning cycle is determined based on at least one of temperature of the memory device, a number of program/erase cycles performed on the memory device, and a bit error count of the memory device.

10. The data storage system of claim 1,
wherein the operation command comprises at least one of a read command for a reading operation and a programming command for a programming operation, and
wherein the standby time is determined based on a read time of the reading operation or a programming time of the programming operation.

11. A data storage system comprising:
a memory controller configured to transmit an operation command for an operation of a memory device in response to a host request;
a memory device configured to perform the operation according to the operation command; and
a timing management module configured to:
identify an operation time of the operation; and
perform an initializing operation to determine a standby time based on the operation time of the operation,
wherein the memory controller is configured to, after the standby time is elapsed, transmit a status identifying command to the memory device to identify status information of the memory device.

12. The data storage system of claim 11,
wherein the memory device comprises a plurality of pages which are grouped into a plurality of groups based on at least one of a memory cell type of each page of the plurality of pages and location information of each page, and
wherein each page of the plurality of pages is included in any one of the plurality of groups.

13. The data storage system of claim 12,
wherein the timing management module is configured to:
identify information on a time at which a signal corresponding to the status information is updated; and
store a plurality of operation times of the plurality of pages based on the information on the time.

14. The data storage system of claim 13,
wherein the timing management module is configured to:
identify the plurality of operation times of each page of multiple pages included in a target group among the plurality of groups;
calculate a representative value of the plurality of operation times; and
determine the representative value as the standby time of the target group.

15. The data storage system of claim 13,
wherein the memory controller is configured to:
identify a target group, among the plurality of groups, that comprises a target page corresponding to the operation command; and
transmit the status identifying command to the target page after the standby time is elapsed.

16. The data storage system of claim 11,
wherein the timing management module is configured to perform a tuning cycle on the memory device to reset the standby time, and
wherein the tuning cycle is determined based on at least one of a temperature of the memory device, a number of program/erase cycles performed on the memory device, and a bit error count of the memory device.

17. An operation method of a data storage system, the operation method comprising:
performing an initializing operation to determine a standby time based on an operation time for an operation of a memory device; and
after the standby time is elapsed, transmitting a status identifying command to identify status information of the memory device,
wherein the status information represents one of statuses including a busy status and a ready status.

18. The operation method of claim 17,
wherein the memory device comprises a plurality of pages which are grouped into a plurality of groups based on at least one of a memory cell type of each page of a plurality of pages included in the memory device and location information thereof, and
wherein each page of the plurality of pages is included in any one of the plurality of groups.

19. The operation method of claim 18,
wherein performing the initializing operation comprises:
identifying information on a time at which a signal corresponding to the status information is updated;
storing a plurality of operation times based on the information on the time;
identifying the plurality of operation times each page of multiple pages included in a target group among the plurality of groups;
calculating a representative value of the plurality of operation times; and
determining the representative value as the standby time of the target group.

20. The operation method of claim 17, further comprising:
performing a tuning operation in which the standby time of the memory device is reset,
wherein a tuning cycle of the tuning operation is determined based on at least one of a temperature of the memory device, a number of program/erase cycles performed on the memory device, and a bit error count of the memory device.
